(19) United States
(12) Patent Application Publication
(10) Pub. No.: US 2010/0116961 A1
(43) Pub. Date: May 13, 2010

(54) Foldable System for Supporting Multiple Computer Monitors

(76) Inventor: Jerry Moscovitch, Toronto (CA)

Correspondence Address: MASS ENGINEERED DESIGN INC., 474 WELLINGTON STREET WEST, TORONTO, ON, M5V-1E3, CA

(21) Appl. No.: 12/614,869

(22) Filed: Nov. 9, 2009

Related U.S. Application Data
(60) Provisional application No. 61/112,294, filed on Nov. 7, 2008.

(51) Int. Cl. F16M 11/38

(52) U.S. Cl. 248/371

(57) ABSTRACT

Described herein is a system having a low profile storage position for supporting multiple computer monitors. The system includes a base, a support column connected to the base, and an arm assembly connected to the support column for supporting multiple computer monitors. A base-column hinge, near where the support column connects to the base, has a substantially horizontal rotation axis when the base rests on a horizontal surface that allows the support column to fold downwards to become substantially parallel to the base. The arm assembly includes a first hinge for rotating a first portion of the arm assembly from an extended position to a folded position and a second hinge for rotating a second portion of the arm assembly opposite the first portion from an extended position to a folded position.

### CROSS REFERENCE TO RELATED APPLICATION

This application claims priority to provisional application No. 60/112,294, filed on Nov. 7, 2008.

### FIELD OF THE INVENTION

The invention relates to multi-monitor display devices and more specifically to stands for supporting more than one computer monitor.

### BACKGROUND OF THE INVENTION

The number of multi-monitor or multi-screen computer display systems has increased in recent years as computer users in various industries adapt their use to new environments. For example, a multi-monitor display system can be used to create the illusion of a larger screen, thereby allowing a securities trader to view a large single spreadsheet over several displays. Alternately, the trader may view individual applications on individual screens (for example, one screen may display a Web Browser, a second a new service and a third a spreadsheet of financial data).

Individuals working with still or moving images, such as graphics artists, video or film editors or medical diagnosticians may also use multi-monitor display systems. A given image may be viewed across several screens or two images may be viewed side-by-side (such as two x-ray images used to assess the extent to which a broken bone has healed).

Conventional stands for multi-monitor display systems can be large and unwieldy, making packing of such stands for transport or storage inefficient. Thus, there is a need to provide a stand for multiple monitors that is more compact than conventional stands.

### SUMMARY OF THE INVENTION

Described herein is a system having a low profile storage position for supporting multiple computer monitors. The system includes a base, a support column connected to the base, and an arm assembly connected to the support column for supporting multiple computer monitors. A base-column hinge, near where the support column connects to the base, has a substantially horizontal rotation axis when the base rests on a horizontal surface that allows the support column to fold downwards to become substantially parallel to the base. The arm assembly includes a first hinge for rotating a first portion of the arm assembly from an extended position to a folded position and a second hinge for rotating a second portion of the arm assembly opposite the first portion from an extended position to a folded position.

Various embodiments have optional features such as: in the folded positions, the first and second portions are substantially parallel to the rest of the arm assembly, the first hinge has a substantially vertical axis of rotation for rotating the first portion about that axis, the longitudinal length of the first portion is substantially the same as the longitudinal length of the second portion, the first portion can rotate about 180 degrees, the first hinge has a horizontal rotation axis that allows the first portion to rotate 90 degrees thereabout such that in the folded position the first portion is substantially parallel to the support column, the horizontal axis is substantially perpendicular to the arm assembly when the first portion is in the extended position. In the folded position, the first portion can be less than one centimeter from the support column or the first portion can nest within the support column.

### BRIEF DESCRIPTION OF THE DRAWINGS

FIG. 1 shows a perspective view of a system for supporting multiple computer monitors, according to the principles of the present invention.

FIG. 2 shows a perspective view of the system of FIG. 1 with the monitors removed.

FIG. 3 shows a perspective view of the system of FIG. 1 with first and second portions of the arm assembly in the folded positions.

FIG. 4 shows a perspective view of the system of FIG. 1 with the first and second portions in their folded positions, and the support column also folded down.

FIG. 5 shows a perspective view of another embodiment of a system for supporting multiple computer monitors in which the rotational axis of the hinges on the arm assembly have different orientation than those in FIG. 1, in accordance with the principles of the present invention.

FIG. 6 shows a perspective view of the system of FIG. 5 illustrating first second portions of the arm assembly nesting within grooves, respectively when in the folded position.

FIG. 7 shows a perspective view of another embodiment of a system for supporting multiple computer monitors, in accordance with the principles of the present invention.

FIG. 8 shows a perspective view of the system of FIG. 7 in a folded position.

FIG. 9 a perspective view of another embodiment of a system for supporting multiple computer monitors that includes hinges in the base and arm assembly, in accordance with the principles of the present invention.

FIG. 10 shows a perspective view of the system of FIG. 9 in a folded position.

FIG. 11 shows a close up of a hinge, and surrounding area, of the system in FIG. 9.

FIG. 12 shows a perspective view of another embodiment of a system for supporting multiple computer monitors, in accordance with the principles of the present invention.

FIG. 13 shows the system of FIG. 12 with arm portions partly rotated.

FIG. 14 shows the system of FIG. 12 in a folded position.

### DETAILED DESCRIPTION

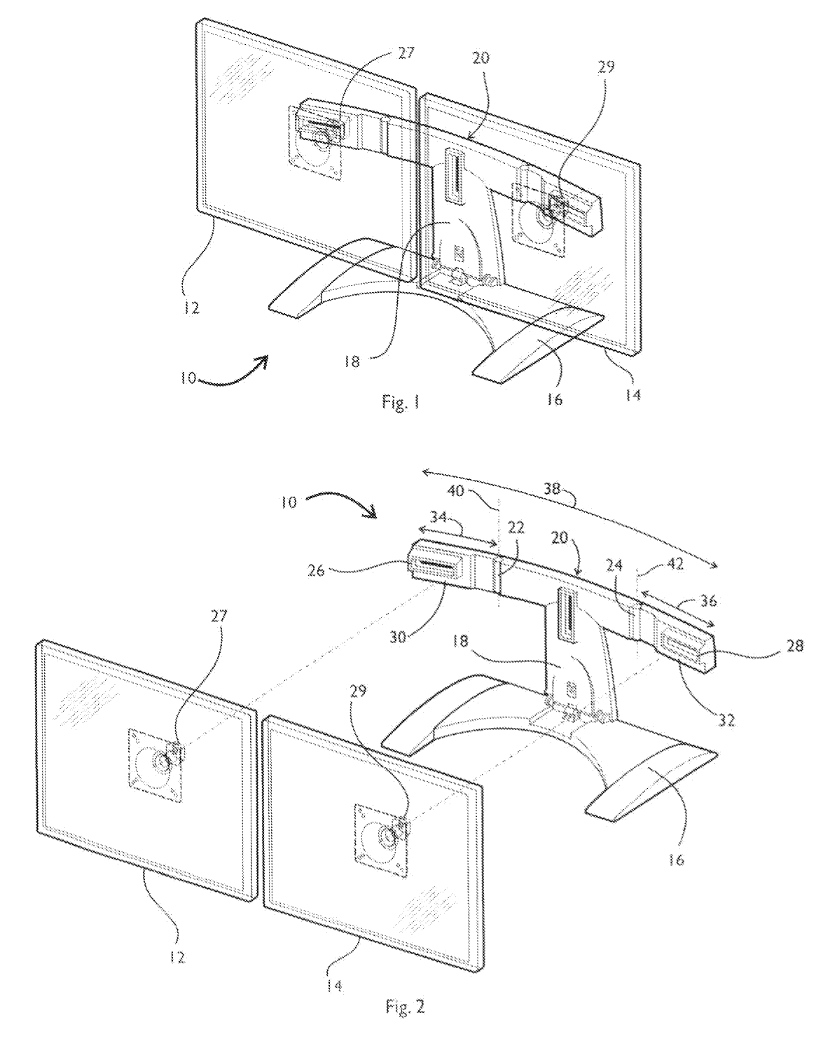

FIG. 1 shows a system 10 for supporting multiple computer monitors 12 and 14. FIG. 2 shows the same system 10 but with the monitors 12 and 14 removed. The system 10 includes a base 16, a support column 18 connected to the base 16, and an arm assembly 20 connected to the support column 18. The arm assembly 20 includes a first hinge 22 and a second hinge 24. The arm assembly 20 includes a first connector station 26 and a second connector station 28 for attaching first and second connectors 27 and 29 thereto.

The base 16 engages a support surface (not shown), such as a desk or wall, which supports the system 10. The support column 18 supports the arm assembly 20 from the base 16. Monitors 12 and 14 are removably connected to the arm assembly 26 via the connectors 27 and 29. The connectors 27 and 29 can include a ball and socket connector for removably and rotatably connecting the monitors 12 and 14 to the arm assembly 20. An appropriate ball and socket connector for removably connecting a display monitor is taught in U.S. Pat. No. 6,702,604 to Jerry Moscovitch. Other connectors may also be used.

The arm assembly 20 includes the first hinge 22 for rotating a first portion 30 of the arm assembly 20 from an extended position to a folded position. Likewise, the arm assembly 20 includes the second hinge 24 for rotating the second portion 32 of the arm assembly 20 from an extended position to a folded position. The first and second portions 30 and 32 are shown in their extended positions in FIG. 2.

In the embodiment shown in FIG. 2, the longitudinal length 34 of the first portion 30 is substantially the same as the longitudinal length 36 of the second portion 32, and the longitudinal length 34 of the first portion 30 is about one quarter the longitudinal length 38 of the arm assembly 20 when the first and second portions 30 and 32 are in their extended positions.

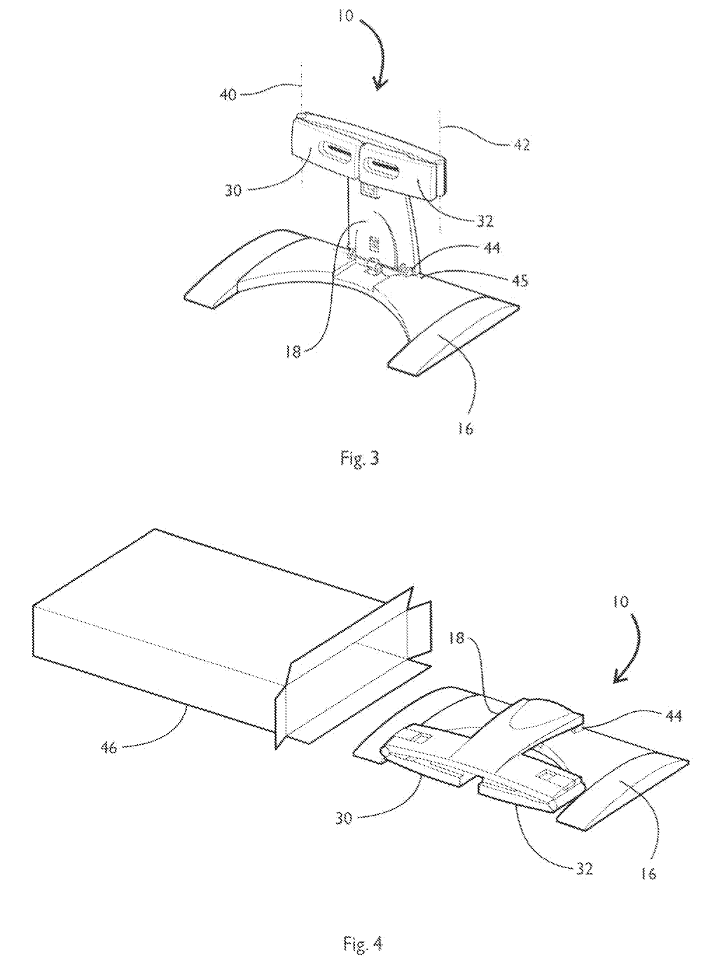

FIG. 2 shows the system 10 with the first and second portions 30 and 32 in the extended positions. FIG. 3 shows the system 10 with the first and second portions 30 and 32 in the folded positions. In rotating from the extended position to the folded position, the first portion 30 rotates approximately 180 degrees counter-clockwise (as viewed from the top) about a substantially vertical axis of rotation 40. Likewise, in rotating from the extended position to the folded position, the second portion 32 rotates approximately 180 degrees clockwise about a substantially vertical axis of rotation 42. It should be understood that instead or in addition, the first portion 30 could rotate 180 degrees clockwise and the second portion 32 could rotate 180 degrees counter-clockwise. In such case, the first and second portions would face the back of the arm assembly 20 instead of the front of the arm assembly as shown in FIG. 3.

The system 10 may further include a hinge 44 near where the support column 18 meets the base 16. The hinge 44 has a horizontal rotation axis 45 that is substantially parallel to the arm assembly 20 when the first and second portions 30 and 32 are in their extended positions. The hinge 44 allows the support column 18 to fold downwards approximately 90 degrees, as shown in FIG. 4.

Referring to FIG. 4, advantageously, when in the first and second portions 30 and 32 are in their folded positions, and the support column 18 is also folded down, the system 10 is more compact for shipping or storage in a box 46, for instance.

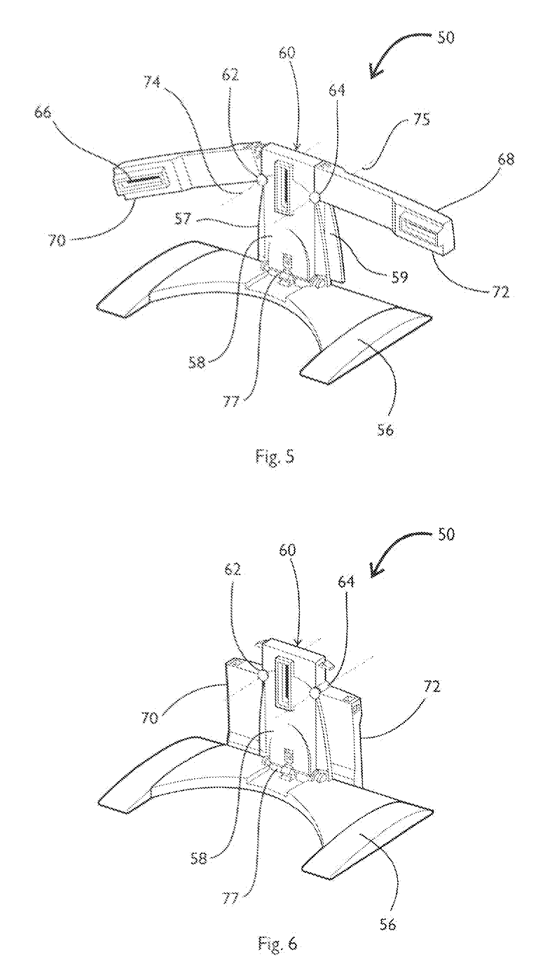

FIG. 5 shows another embodiment 50 of the present invention in which the rotational axis of the hinge has a different orientation. The system 50 includes a base 56, a support column 58 with grooves 57 and 59 on either side thereof. The support column 58 is connected to the base 56, and an arm assembly 60 is connected to the support column 58. The arm assembly 60 includes a first hinge 62 and a second hinge 64. The arm assembly 60 includes a first connector station 66 and a second connector station 68 for attaching monitor connectors (not shown in FIGS. 5 and 6) thereto.

The arm assembly 60 includes the first hinge 62 for rotating a first portion 70 of the arm assembly 60 from an extended position to a folded position. Likewise, the arm assembly 60 includes the second hinge 64 for rotating a second portion 72 of the arm assembly 60 from an extended position to a folded position. The second portion 72 is shown in its extended position in FIG. 5.

In the embodiment shown in FIG. 5, the first hinge 62 has a horizontal rotation axis 74. The horizontal rotation axis 74 is substantially perpendicular to the arm assembly 60 when the first portion 70 is in the extended position. The first portion 70 of the arm assembly 60 can rotate 90 degrees about the horizontal rotation axis 74 from the extended position to the folded position such that in the folded position, the first portion 70 is substantially parallel to the support column 58. Likewise, the second hinge 64 has a horizontal rotation axis 75. FIG. 6 shows the arm assembly 60 with the first and second portions 70 and 72 in the folded positions. A hinge 77 near the junction of the base 56 and support column 58 also allows the support column 58 to assume a folded position.

In the embodiment of FIG. 6, the first portion 70 and the second portion 72 nest within the grooves 57 and 59, respectively, of the support column 58 when in the folded position. In other embodiments, the first portion can be adjacent but not touching the support column, or the first portion can rest on a support column with no grooves when in the folded position.

In FIG. 7, another embodiment of a system 90 for supporting multiple computer monitors is shown. The system 90 includes a base 92 for resting on a horizontal surface. The base 92 includes a first base portion 94 and a second base portion 96. A support column 98 is connected to the base 92. The system 90 further includes an arm assembly 100 connected to the support column 98 for supporting multiple computer monitors (not shown in FIG. 7). The system 90 additionally includes a first hinge 102 in the first base portion 94 having a first rotation axis 104 that is substantially perpendicular to the arm assembly and substantially horizontal when the base 92 is resting on the horizontal support surface. The first base portion 94 can rotate about the first rotation axis 104 from an extended position to a folded position. Likewise, the system 90 further includes a second hinge 106 in the base 92 having a second rotation axis 108 that is substantially perpendicular to the arm assembly 100 and substantially horizontal when the base 92 is resting on the horizontal support surface. The second base portion 96 can rotate about the second rotation axis 108 from an extended position to a folded position.

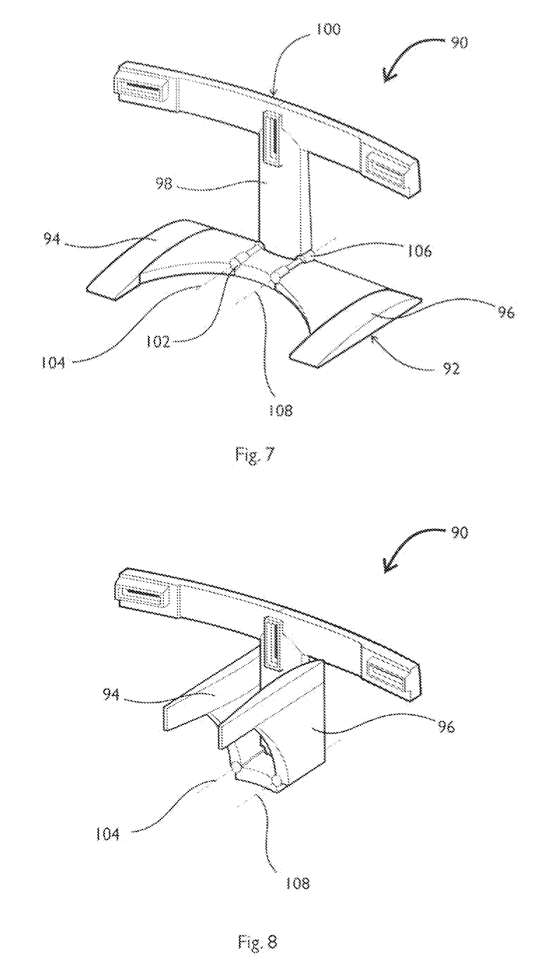

In FIG. 7, the first and second base portions 94 and 96 are shown in their extended positions. In FIG. 8, the first and second base portions 94 and 96 are shown in their folded positions. In the embodiment shown in FIG. 8, the first base portion 94 rests against the support column 98 when the first base portion 94 is in the folded position, and the second base portion 96 rests against the support column 98 when the second base portion 96 is in the folded position.

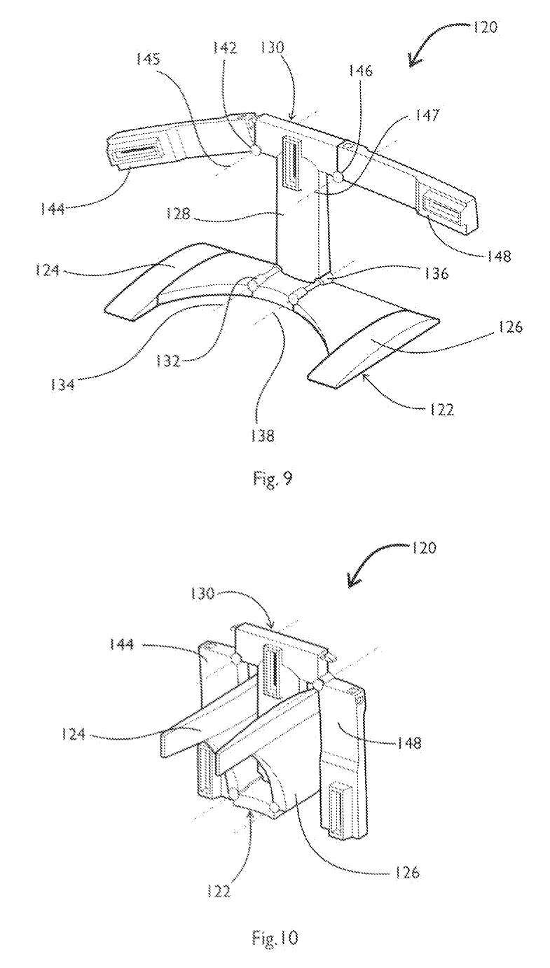

In FIG. 9, another embodiment of a system 120 for supporting multiple computer monitors is shown that includes hinges in the base and arm assembly. The system 120 includes a base 122 for resting on a horizontal surface. The base 122 includes a first base portion 124 and a second base portion 126. A support column 128 is connected to the base 122. The system 120 further includes an arm assembly 130 connected to the support column 128 for supporting multiple computer monitors (not shown in FIG. 9).

The system 120 additionally includes a first hinge 132 in the first base portion 124 having a first rotation axis 134 that is substantially perpendicular to the arm assembly 130 and substantially horizontal when the base 122 is resting on the horizontal support surface. The first base portion 124 can rotate about the first rotation axis 134 from an extended position to a folded position. Likewise, the system 120 further includes a second hinge 136 in the base 122 having a second rotation axis 138 that is substantially perpendicular to the arm assembly 130 and substantially horizontal when the base 122 is resting on the horizontal support surface. The second base portion 126 can rotate about the second rotation axis 138 from an extended position to a folded position. The hinges 132 and 136 are similar to hinges 102 and 106 shown in FIGS. 7 and 8.

The system 120 also includes a first hinge 142 for rotating a first portion 144 of the arm assembly 130 from an extended position to a folded position. The first hinge 142 has a first rotation axis 145 that is substantially perpendicular to the arm assembly 130 and substantially horizontal when the base 122 is resting on the horizontal support surface. Likewise, the arm assembly 130 includes a second hinge 146 for rotating a second portion 148 of the arm assembly 130 from an extended position to a folded position. The second hinge 146 has a second rotation axis 147 that is substantially perpendicular to the arm assembly 130 and substantially horizontal when the base 122 is resting on the horizontal support surface. The hinges 142 and 146 are similar to hinges 62 and 64 of FIGS. 5 and 6.

The first base portion 124, the second base portion 126 and the second portion 148 of the arm assembly 130 are shown in their extended positions in FIG. 9. The first base portion 124, the second base portion 126, the first portion 144 of the arm assembly 130 and the second portion 148 of the arm assembly 130 are all shown in their folded positions in FIG. 10.

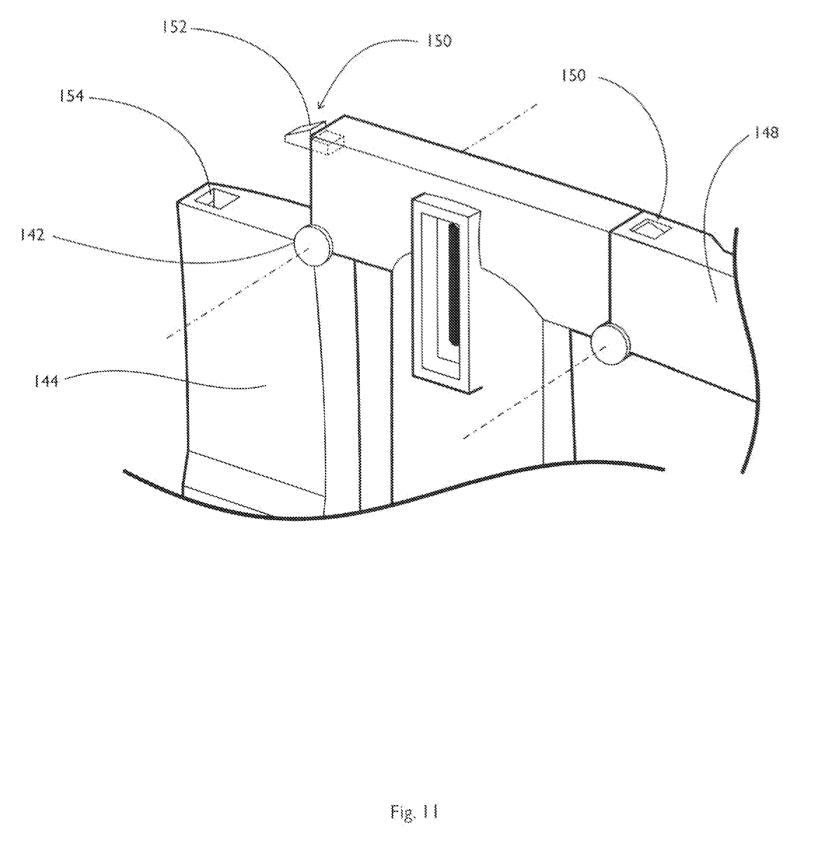

FIG. 11 shows a close up of the hinge 142 and surrounding area. A securing mechanism 150, such as a latch, having a flexible projection 152 mates with a mating member 154. When the first portion 144 is rotated into the extended position, the flexible portion 152 deflects before mating with the mating member 154 to securely maintain the first portion 144 in the extended position even as the first portion 144 supports a monitor. To rotate the first portion 144 from the extended position to the folded position, the flexible projection 152 is depressed to clear the mating member 154 to allow rotation of the first portion into the folded position. Aside from the latch 150, other means can also be used to secure the first portion in the extended position, such as clasps, screws and clamps.

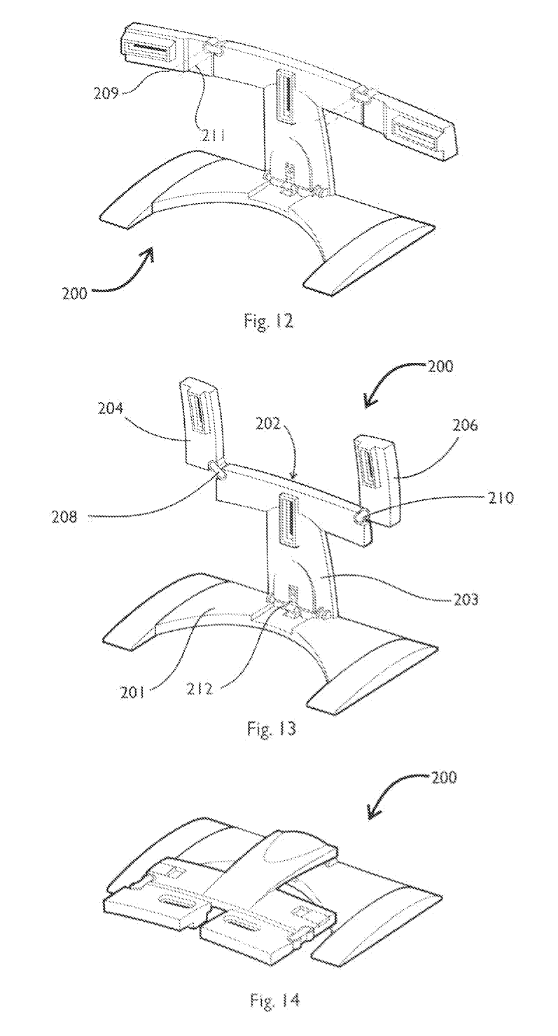

In the embodiments shown in FIGS. 5, 6 and 9, the first portion of the arm assembly rotates counter-clockwise when moving from the extended position to the folded position. In other embodiments, the first portion can rotate clockwise, so that the first portion is substantially above the support column when in the folded position. FIGS. 12-14 show such an embodiment of a system 200 for supporting multiple computer monitors. The system 200 also includes a base 201 for supporting a support column 203 therefrom. The system 200 includes an arm assembly 202 having a first portion 204 and a second portion 206. The arm assembly 202 includes a first double hinge 208 and a second double hinge 210.

The arm assembly 202 includes the first double hinge 208 for rotating the first portion 204 of the arm assembly 202 from an extended position to a folded position. Likewise, the arm assembly 202 includes the second double hinge 210 for rotating the second portion 206 of the arm assembly 202 from an extended position to a folded position. The first and second portions 204 and 206 are shown in their extended positions in FIG. 12.

The first double hinge 208 includes two parallel rotation axes 209 and 211 that provide two degrees of freedom and allow the first portion 204 to assume the folded position of FIG. 14. The second double hinge 210 allows the second portion 206 to assume a folded position, as also shown in FIG. 14. FIG. 13 shows the first and second portions 204 and 206 in intermediate rotated positions. Disposing the first and second double hinges 208 and 210 at the top of the arm assembly 202 obviates the need for a securing mechanism, such as a latch, to secure the first and second portions in the extended positions.

The system 200 of FIGS. 12-14 also includes a hinge 212 at the base 201 for folding the support column 203. The resultant folded configuration, shown in FIG. 14, results in a quite flat geometry for the system 200, which is conducive to efficient packing for shipping or storing.

It will be appreciated that the embodiments described herein are exemplary only and are not meant to limit the scope of the invention whose scope is defined by the following claims.

What is claimed is:

1. A system having a low profile storage position for supporting multiple computer monitors, the system comprising:
a base;
a support column connected to the base;
an arm assembly connected to the support column for supporting multiple computer monitors; and
a base-column hinge near where the support column connects to the base, the base-column hinge having a substantially horizontal rotation axis when the base rests on a horizontal surface that allows the support column to fold downwards to become substantially parallel to the base, wherein a) the arm assembly includes a first hinge for rotating a first portion of the arm assembly from an extended position to a folded position and b) the arm assembly includes a second hinge for rotating a second portion of the arm assembly opposite the first portion from an extended position to a folded position.

2. The system of claim 1, wherein in the folded positions the first and second portions are substantially parallel to the rest of the arm assembly.

3. The system of claim 1, wherein the first hinge has a substantially vertical axis of rotation for rotating the first portion about that axis.

4. The system of claim 1, wherein the longitudinal length of the first portion is substantially the same as the longitudinal length of the second portion.

5. The system of claim 4, wherein the longitudinal length of the first portion is about one quarter the longitudinal length of the arm assembly when the first and second portions are in their extended positions.

6. The system of claim 3, wherein the first portion can rotate about 180 degrees.

7. The system of claim 2, wherein the first hinge has a horizontal rotation axis that allows the first portion to rotate 90 degrees thereabout such that in the folded position the first portion is substantially parallel to the support column.

8. The system of claim 7, wherein the horizontal axis is substantially perpendicular to the arm assembly when the first portion is in the extended position.

9. The system of claim 8, wherein in the folded position the first portion is less than one centimeter from the support column.

10. The system of claim 7, wherein in the folded position some of the first portion nests within the support column.

11. The system of claim 1, wherein in the folded positions the first and second portions are substantially parallel to the support column.
